(19) United States
(12) Patent Application Publication
(10) Pub. No.: US 2025/0135440 A1
(43) Pub. Date: May 1, 2025

(54) HYDRODEOXYGENATION CATALYSTS

(71) Applicants: Johnson Matthey Public Limited Company, London (GB); Virent, Inc., Madison, WI (US)

(72) Inventors: Brian Blank, Madison, WI (US); Dana Hatch, Madison, WI (US); Philip John Hughes, Billingham (GB); Paul Andrew McGuire, Billingham (GB); Maria Elena Rivas-Velazco, Reading (GB); Stuart Michael Small, Billingham (GB); Edgar Steenwinkel, Madison, WI (US); Stephen Gary Wainwright, Billingham (GB)

(21) Appl. No.: 18/926,188

(22) Filed: Oct. 24, 2024

Related U.S. Application Data
(60) Provisional application No. 63/593,768, filed on Oct. 27, 2023.

(30) Foreign Application Priority Data
Dec. 6, 2023 (GB) 2318629.9

(51) Int. Cl. B01J 23/44; B01J 23/62; B01J 23/652; B01J 35/00; B01J 35/50; B01J 35/51; B01J 35/61; B01J 35/63; B01J 37/02; B01J 37/08

(52) U.S. Cl. CPC B01J 23/44; B01J 23/626; B01J 23/6525; B01J 35/19; B01J 35/505; B01J 35/51; B01J 35/612; B01J 35/633; B01J 37/0209; B01J 37/08

(57) ABSTRACT

The specification describes a catalyst for the hydrodeoxygenation of alcohols, comprising: 0.1 to 1.5 wt % palladium; 1.0 to 5.0 wt % molybdenum; and 0.05 to 0.5 wt % tin; on a zirconia support. Also described is a method for manufacturing the catalyst and a hydrodeoxygenation process using the catalyst.

### FIELD OF THE INVENTION

The present invention relates to catalysts for the hydrodeoxygenation of feed streams, particularly for the conversion of sugars, sugar alcohols and other carbohydrates into lower molecular weight oxygenated compounds.

### BACKGROUND

There is an urgent need for alternatives to fossil fuels. Biomass (material derived from living or recently living biological materials) is one category of possible renewable alternatives. A key challenge for promoting and sustaining the use of biomass is the need to develop efficient and environmentally benign technologies for converting biomass into useful products.

One such commercial process for the conversion of biomass to fuels is marketed by Virent Inc under the name BioForming™. This process involves extracting soluble carbohydrates from biomass, converting the biomass into reactive intermediates through a combination of aqueous phase reforming (APR) and/or hydrodeoxygenation (HDO), followed by further reactions to generate hydrocarbons. This process is described in U.S. Pat. No. 9,314,778B2 (Virent, Inc) and the references cited therein.

A key requirement of the HDO process is to effectively remove oxygen from the carbohydrate without a significant disruption of the corresponding carbon backbone. U.S. Pat. No. 9,314,778B2 compares the performance of monometallic, bimetallic and trimetallic catalysts in the HDO reaction. Trimetallic catalysts described include 2% Pd-2% Mo-0.5% Sn on tungstated zirconia (Examples 24, 35) or 2% Pd-5% Mo-1% Sn on tungstated zirconia (Example 26), in each case using a tungstated zirconia from Norpro as the support. These catalysts were tested for their performance in converting a food grade corn syrup feedstock to monooxygenates. When compared to a 3% Pd on tungstated zirconia catalyst, these trimetallic catalysts gave a similar monooxygenate yield but a much lower yield of the undesired C7+ condensation products (see Table 9 of reference). Mono-, bi- and trimetallic catalysts for the HDO reaction are also described in U.S. Pat. No. 10,131,602B2.

While the Pd—Mo—Sn on tungstated zirconia catalysts show good performance in the HDO reaction there is room for further improvement. It would be advantageous if the amount of palladium could be reduced without sacrificing activity.

The present invention addresses these problems.

### SUMMARY OF THE INVENTION

By careful selection of the amounts of Pd, Mo and Sn the present inventors have surprisingly managed to provide catalysts with comparable, or better, activity in the HDO reaction while having lower palladium content than previous HDO catalysts. Furthermore, the inventors have managed to simplify the catalyst preparation route so that it involves only a single impregnation step and is therefore much easier to implement at scale.

In a first aspect the invention relates to a catalyst for the hydrodeoxygenation of alcohols, comprising:
0.1 to 1.5 wt % palladium;
1.0 to 5.0 wt % molybdenum; and
0.05 to 0.5 wt % tin;
on a zirconia support.

In a second aspect the invention relates to a method of manufacturing a hydrodeoxygenation catalyst, comprising the steps of:
(i) dissolving a palladium salt, a molybdenum salt, a tin salt and a chelating agent together to produce an impregnation solution;
(ii) adding the impregnation solution to a zirconia support to provide an impregnated support;
(iii) drying the impregnated support; and
(iv) calcining the impregnated support to produce the hydrodeoxygenation catalyst;
   wherein the hydrodeoxygenation catalyst is as defined in the first aspect.

In a third aspect the invention relates to a hydrodeoxygenation process comprising the step of treating a feed stream comprising a carbohydrate feedstock with a catalyst to produce a lower molecular weight oxygenated compound, wherein the catalyst is defined in the first aspect.

### DESCRIPTION OF THE FIGURES

FIG. 1 shows the relationship between basic sites/BET surface area and activity.

FIG. 2 shows the relationship between acidic sites/BET surface area and activity.

FIG. 3 shows how the average diameter of a trilobe is measured; the trilobe shown has an average diameter of 1.4 mm.

### DETAILED DESCRIPTION

Any sub-headings are included for convenience only and are not to be construed as limiting the disclosure in any way.

### Catalyst

The invention also relates to a catalyst for the hydrodeoxygenation of alcohols, comprising:
0.1 to 1.5 wt % palladium;
1.0 to 5.0 wt % molybdenum;
0.05 to 0.5 wt % tin;
on a zirconia support.

For the avoidance of doubt, the wt % of metal refers to the amount of metal relative to the weight of catalyst as a whole.

Studies by the present inventors have shown that increasing palladium and/or molybdenum content is associated with increasing catalyst performance. While the presence of some tin is required to achieve adequate performance, increasing the tin content above 0.5 wt % negatively impacts performance. The inventors have therefore found that if the content of tin is kept low then the content of palladium can also be kept low. This is surprising, and the loadings of palladium and tin suggested herein are significantly different from the loadings of the trimetallic examples described in U.S. Pat. No. 9,314,778 B2 (Examples 24, 26 and 35) which include 2 wt % palladium and either 0.5 wt % or 1 wt % tin.

Palladium is currently a highly expensive metal and therefore the palladium loading should be as low as possible without negatively impacting performance. It is preferred that the catalyst comprises 0.1 to 1.5 wt % palladium, such as 0.1 to 1.2 wt % palladium or 0.1 to 1.0 wt % palladium. In some embodiments the palladium loading is 0.3 to 1.5 wt % palladium, such as 0.3 to 1.2 wt % palladium or 0.3 to 1.0 wt % palladium.

While increasing the Mo content seems to improve catalyst performance, too much Mo should be avoided for cost reasons. It is preferred that the catalyst comprises 1.0 to 5.0 wt % molybdenum, such as 1.0 to 3.0 wt %, such as 1.0 to 2.5 wt %.

While the presence of some tin is required to achieve adequate performance, increasing the tin content above 0.5 wt % negatively impacts performance. The catalyst therefore includes 0.05 to 0.5 wt % tin. It is preferred that the catalyst includes 0.05 to 0.3 wt % tin, such as 0.1 to 0.3 wt % tin.

It is preferred that the content of metals other than palladium, molybdenum, tin and zirconium present in the catalyst is ≤0.1 wt % based on the total weight of the catalyst, if any such metals are present at all. Preferably the content of such other metals is ≤0.05 wt %, such as ≤0.01 wt %.

A preferred catalyst comprises:
0.1 to 1.5 wt % palladium;
1.0 to 3.0 wt % molybdenum; and
0.05 to 0.3 wt % tin.

Studies by the present inventors have shown that catalyst activity in the HDO reaction also correlates with metal surface area. It is preferred that the catalyst has a metal surface area of ≥1.0 m²/g_{cat} when measured by CO chemisorption following the procedure reported in the examples section. Typical surface areas are 1.0 to 5.5 m²/g_{cat}, such as 1.0 to 3.0 m²/g_{cat} such as 1.0 to 2.5 m²/g_{cat}.

### Manufacture of the Catalyst

The catalyst described herein can be prepared by a sequential impregnation procedure or by a co-impregnation procedure. An advantage of a co-impregnation procedure is that it is easier to scale than a sequential impregnation procedure. Where a co-impregnation procedure is used, it is preferred that a chelating agent is included to stabilise the metals in solution. A preferred chelating agent is citric acid.

The palladium salt may be a palladium (II) or a palladium (IV) salt, preferably a palladium (II) salt. Palladium (II) nitrate is particularly preferred.

Any suitable molybdenum salt may be used. A preferred salt is ammonium molybdate ((NH₄)₆Mo₇O₂₄)) which is readily available commercially.

The procedure described in U.S. Pat. No. 9,314,778 used tin (IV) chloride as the tin salt. While various tin (IV) salts may be used in the present invention, tin (IV) oxalate is preferred because it is less hazardous to health.

The zirconia support used in step (ii) is preferably as defined in the “support” section.

### Support

The support preferably comprises ≥95 wt % ZrO₂ based on the total weight of the support. The amount of metal oxides other than ZrO₂ is preferably ≤5 wt % (support comprises ≥95 wt % ZrO₂), preferably ≤4 wt % (support comprises ≥96 wt % ZrO₂), ≤3 wt % (support comprises ≥97 wt % ZrO₂), ≤2 wt % (support comprises ≥98 wt % ZrO₂), ≤1 wt % (support comprises ≥99 wt % ZrO₂).

The support preferably has a total pore volume of 0.10 to 0.40 mL/g when measured by the procedure reported in the examples. A typical total pore volume is 0.12 to 0.30 mL/g.

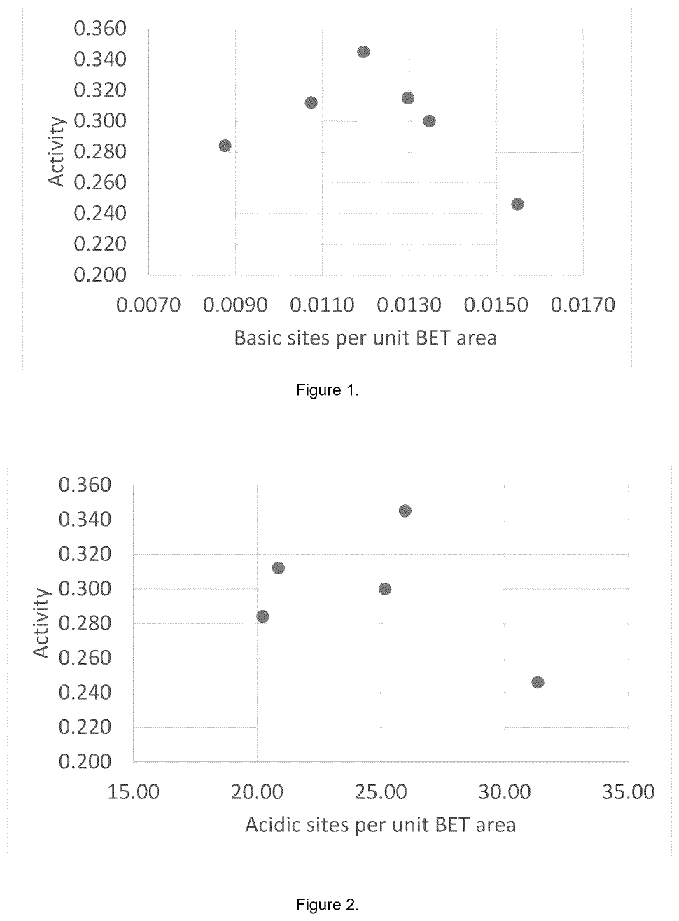

The support preferably has a basic site density of 0.006 to 0.015 wt %/m² as measured by the MBOH test reported in the examples, preferably of 0.075 to 0.014 wt % wt %/m². Supports having a basic site density within these ranges have optimal performance as HDO catalyst when impregnated with Pd, Mo and Sn, as is shown in FIG. 1.

The support preferably has an acid site density of 15 to 30 μL_{NH3}/m² when measured by the procedure reported in the examples, preferably 19 to 28 μL_{NH3}/m². Supports having an acid site density within these ranges have optimal performance as HDO catalyst when impregnated with Pd, Mo and Sn, as is shown in FIG. 2.

It is preferred that the support has a crush strength of 20 to 140 N when measured by the procedure reported in the examples. A typical crush strength is 20 to 80 N, such as 20 to 60 N.

In one embodiment the support is a tungstated catalyst comprising ≥95 wt % ZrO₂ and ≤5 wt % WO₃. These supports may be used for preparing a HDO catalyst, as described in U.S. Pat. No. 9,314,778 B2.

In one embodiment the support is essentially free of tungsten (W), for example comprising ≤0.1 wt % W, such as ≤0.05 wt % W.

In one embodiment the support has a spherical cross-section.

In a preferred embodiment the support has a trilobe or tetralobe cross-section. A particularly preferred support has a trilobe cross-section with an average diameter of 1.0 to 4.0 mm, such as 1.0 to 2.0 mm.

### Manufacture of Support

The inventors investigated the use of zirconia (ZrO₂) or Zr(OH)₄ as a raw material in step (i). It was possible to produce supports having good radial crush strength regardless of which raw material was used.

Any suitable lubricant may be used in step (i). Preferred lubricants include microcrystalline cellulose, hydroxymethyl cellulose or a metal stearate. Typically the lubricant and either ZrO₂ or Zr(OH)₄ are dry blended in step (i).

Step (ii) involves the formation of an extrudate or tablet. In the case of extrusion, an additive is first added to the product mixture from step (i). The additive is typically provided as an aqueous solution. The primary role of the additive is to act as a binder for the ZrO₂ or Zr(OH)₄ raw material. Without wishing to be bound by any theory, it is thought that the additive may cause cross linking (in the case of zirconium acetate or zirconium nitrate) or peptising (in the case of nitric acid or ammonium hydroxide). The inventors have found that the choice of additive affects the acid/base properties of the resulting zirconia support, which can impact on the suitability of the support for the catalyst in question.

In some embodiments the additive is ammonia or an acid, such as nitric acid. In both cases, the support had acceptable strength and performed well as HDO catalysts.

While the addition of ammonia or an acid as an additive produced a support with good strength and good to excellent performance as HDO catalysts, the use of ammonia or an acid may not be be compatible with manufacturing equipment. Therefore, in some embodiments a zirconium salt is used. Preferred zirconium salts include zirconium nitrate, zirconium acetate and ammonium zirconium carbonate. Surprisingly, the use of a zirconium salt as the additive leads to a support with higher strength than could be achieved with ammonia or nitric acid. Therefore, the use of a zirconium salt may be preferred when a high strength zirconia support is desired. The use of zirconium salts, particularly zirconium acetate, is also typically more compatible with manufacturing equipment than either ammonia or acids and they may be preferred for this reason.

In the case of tabletting, it is not necessary to add an additive to the product of step (i) before tabletting.

Step (ii) also involves the formation of a shaped body by extrusion (“extrudates”) or by tabletting (“tablets”). In each case, the cross-section of the shaped body may be spherical (e.g. cylinders) or may be shaped. Preferred shaped bodies have a trilobe or tetralobe cross-section, as this provides a catalyst which has a high geometric surface area which is beneficial for activity. Extrusion and tabletting conditions will be well known to those skilled in the art.

Typically a shaped body formed by extrusion (“extrudate”) will have an elongated shape.

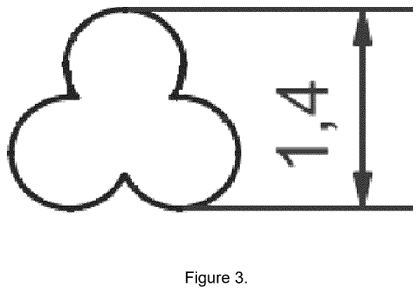

The cross-section of the extrudate may be spherical (i.e. cylindrical extrudates) or may be shaped. Multilobe shapes such as trilobes or tetralobes are preferred, particularly trilobes. A particularly suitable shape is a trilobe with an average diameter of 1.0 to 4.0 mm, such as 1.0 to 2.0 mm. FIG. 3 shows how the average diameter of a trilobe is measured.

Step (iii) involves drying the shaped body to remove excess water. Drying conditions will readily be determined by those skilled in the art.

Step (iv) involves calcining the product of step (iii). The inventors have found that while the calcination temperature does not appear to have a significant impact on support strength, it does impact the performance as an HDO catalyst. When the support is to be used for an HDO catalyst it is preferred that the calcination temperature in step (iv) is between 300-800° C., such as 300-500° C. or 350-450° C. A calcination time of 2-6 hours is typically sufficient although this may vary depending on scale.

### EXAMPLES

### Raw Materials

SGN SZ31164 are commercial zirconia extruates (1.2 mm diameter) from Saint Gobain
ZOH-85 is a commercial Zr(OH)₄ from Zircomet
Z-3186 and is a commercial ZrO₂ from Daiichi Kigenso Kagaku Kogyo Co. Ltd.
RC-100 is a commercial ZrO₂ from Daiichi Kigenso Kagaku Kogyo Co. Ltd.
XZO 631/01 is a commercial Zr(OH)₄ from MEL Chemicals

### General Procedure for Manufacturing Supports

The raw material (ZrO₂ or Zr(OH)₄) was dry mixed with a lubricant (either microcrystalline cellulose, hydroxymethyl cellulose or magnesium stearate). In the case of extruded catalysts, a solution of additive (either 5% ammonia, 5% nitric acid, zirconium nitrate solution or zirconium acetate solution) was added and the mixture was either extruded into trilobes with a 1.3 mm average diameter or into cylinders with a 1.6 mm diameter. In the case of pelleted catalysts, the mixture of raw material and lubricant was pelleted into tablets with a 3.3 mm diameter. The materials were dried (120° C.) and then calcined under the conditions specified.

### Procedure for Measuring Crush Strength

Radial crush strength was measured using an Engineering Systems CT6 instrument. A crush speed of 22 mm/min was used with a 50 kg load cell. 20 individual particulates were analysed and the average value calculated.

### Procedure for Measuring Total Pore Volume and BET Surface Area

Surface area was measured using a Micromeritics 2420 ASAP physisorption analyser by application of the BET method in accordance with ASTM Method D 3663-03; Standard Test for Surface Area. Nitrogen was used as the adsorbate and the measurements carried out at liquid nitrogen temperature. The cross-sectional area of a nitrogen molecule was taken as 16.2 Å². Samples were outgassed prior to analysis by purging with dry nitrogen gas for a minimum of 1 hour at an optimal temperature. Five relative pressure/volume data pairs were obtained over the relative pressure region of 0.05 to 0.20 P/Pₒ inclusive. The equilibration time for each point was 10 seconds. Surface areas are reported based on the weight of the sample post outgassing. Full adsorption/desorption isotherms were measured over the relative pressure range of 0.05 to 0.995 and back to 0.05. The total pore volume was determined at the last point on the adsorption isotherm (0.995 P/Pₒ).

### Procedure for Measuring Acid Site Density

The particulate was ground to a powder and charged to a Micromeritics AutoChem 2950HP thermal analyser. A 40 mL/min flow of helium was passed over the particulate at atmospheric pressure while heating to 400° C. at a rate of 20° C./min. A temperature of 400° C. was maintained for 10 minutes before cooling to 120° C. Once at 120° C. a 40 mL/min flow of helium and a 40 mL/min flow of 5% v/v ammonia in helium was passed over the particulate for 30 minutes. The physisorbed ammonia was purged using a 40 mL/min flow of helium for 30 minutes. The particulate temperature was increased to 700° C. at a rate of 5° C./min and held for 30 minutes, during this time a TCD detector was used to monitor the desorption of ammonia from the particulate. The total amount of ammonia desorbed was calculated by integrating the desorption profile which had been calibrated using known quantities of ammonia in helium. This value was then normalised by the samples BET surface area (measured according to the BET surface area procedure) to obtain the acid site density in μL_{NH3}/m².

### Procedure for Measuring Basic Site Density

This procedure is based on the procedure described in the articles “Evaluation of Surface Acido-Basic Properties of Inorganic-Based Solids by Model Catalytic Alcohol Reaction Networks” (Catalyst Reviews, 48:315-362, 2006) and “Synthesis and Characterization of ZrO2 as Acid-Basic Catalysts: Reactivity of 2-Methyl-3-butyn-2-ol′ (Journal of Catalysis 183, 240-250 (1999)).

6 g of particulate was charged to a static 45 mL autoclave along with 15 mL of 2-Methyl-3-butyn-2-ol (MBOH) and a single droplet of water. This was placed in a furnace/oven and subjected to a temperature of 200° C. for 18 hours before cooling to room temperature. The reaction liquid is analysed by gas chromatography for 2-Methyl-1-buten-3-yne (Mbyne), Mesityl oxide (MO), 2-Methyl-3-butyn-2-ol (MBOH), 3-Methyl-2-butenal (Prenal), 3-Hydroxy-3-methyl-2-butanone (HMB), 4-Hydroxy-4-Hydroxy-4-methyl-2-pentanone (DAA) using external standards. The quantity of Acetone and 4-Hydroxy-4-Hydroxy-4-methyl-2-pentanone (DAA) is added and divided by the particulate BET surface area in 6 g to obtain the basic site density in wt. %_{basic products}/m².

### Procedure for Measuring Metal Surface Area

Palladium metal areas were measured on a Micromeritics HTP 6 Station Chemisorption Analyser by a static (barometric) method.

Approximately 1 g to 2 g of sample was used. The samples were initially heated to 140° C. at 10° C./minute in 100% helium flowing at 50 SCCM and held at 140° C. for 30 minutes. The helium was then switched off and the sample allowed to cool to 35° C. whilst under vacuum. The sample was then heated to 100° C. at 10° C./minute in 100% flowing hydrogen at 50 SCCM and held at 100° C. for 120 minutes to reduce the Pd. After the reduction stage is finished the hydrogen is switched off and the sample evacuated to less than 10 μmHg at 100° C. for 60 minutes. The sample is then cooled under vacuum to 35° C. and evacuation continued for a further 10 minutes under a vacuum of less than 10 μmHg. A leak test is then carried out prior to analysis. An acceptable leak rate is less than 5 μmHg/minute. Any higher than this and the integrity of the sample may be compromised, and lower metal areas may ensue due to re-oxidation of the palladium by air leaking into the system. Metal area analysis is carried out at 35° C. where the sample is dosed with 100% carbon monoxide over a range of pressures between 100 and 760 mmHg. At each pressure the chemisorbing carbon monoxide is allowed to equilibrate, and the volume of gas uptake is measure and recorded automatically. Pressure/uptake pairs constitute a chemisorption isotherm. At the end of the analysis the sample is discharged, and the reduced weight of sample is recorded.

The analysis entails the measurement of two isotherms. The first is a measure of the “total” carbon monoxide taken up by the sample, which includes both chemisorbed and physisorbed carbon monoxide. The sample is then evacuated to remove the physisorbed (“weak”) component and the isotherm repeated to quantify the amount of physisorbed carbon monoxide going back on the sample. The isotherms are inspected to ensure only linear sections are used in the data reduction. The instrument software is used to calculate the Pd surface area based on the total uptake of hydrogen and the difference between the “total” and the “weak” (i.e. the “strong” component) and, by extrapolating the data back to zero pressure, reports the palladium surface areas based on these values. These are generally referred to as Pd area (0tot) and Pd area (0str) respectively (str=strong). The reduced weight is used to express the Pd areas in m²g⁻¹ of reduced catalyst.

### General Co-Impregnation Procedure for Manufacturing HDO Catalysts

The supports S1 and S3 to S7 described in Table 1 were converted into HDO catalysts C1 and C3 to C7 by the following procedure. Zirconia extrudates were loaded into a tumbler. An impregnation solution was prepared by dissolving ammonium molybdate, palladium nitrate solution, tin oxalate and citric acid in deionized water up to the absorption volume of the extrudates. The impregnation solution was added over approximately 2 minutes to the tumbler mixer with gentle rotation (approximately 2 rpm) and the mixture was allowed to tumble for a further 15 mins (approximately 2 rpm). The impregnated tablets were transferred to an oven and dried overnight at 105° C. and then calcined in air at 400° C., with a ramp rate of 2° C./min and held for 4 hours. The resulting catalysts contained 1 wt % Pd, 2 wt % Mo and 0.25 wt % Sn, with the exception of S2 which contained 1 wt % Pd, 1 wt % Mo and 0.25 wt % Sn.

### General Sequential Impregnation Procedure for Manufacturing HDO Catalysts

The support S2 described in Table 1 was converted into HDO catalyst S2 by the following procedure. Zirconia extrudates were loaded into a tumbler. An impregnation solution was prepared by dissolving ammonium molybdate, tin oxalate and citric acid in deionized water up to the absorption volume of the extrudates. The impregnation solution was added over approximately 2 minutes to the tumbler mixer with gentle rotation (approximately 2 rpm) and the mixture was allowed to tumble for a further 15 mins (approximately 2 rpm). The impregnated extrudates were transferred to an oven and dried overnight at 105° C. and then calcined in air at 400° C., with a ramp rate of 2° C./min and held for 4 hours. The catalyst intermediate was then removed from the oven and loaded into a tumbler. An impregnation solution of palladium nitrate was made up to the absorption volume with deionized water. The impregnation solution was added over approximately 2 minutes to the tumbler mixer with gentle rotation (approximately 2 rpm) and the mixture was allowed to tumble for a further 15 mins (approximately 2 rpm). The impregnated extrudates were transferred to an oven and dried overnight at 105° C. and then calcined in air at 400° C., with a ramp rate of 2° C./min and held for 4 hours.

TABLE 1

| | S1 | S2 | S3 | S4 | S5 | S6 | S7 |
|---|---|---|---|---|---|---|---|
| Raw Material | SGN | ZOH-85 | XZO | Z-3186 | RC-100 | Z-3186 | Z-3186 |
| | SZ31164 | Zr(OH)₄ | 631/01 | ZrO₂ | ZrO₂ | ZrO₂ | ZrO₂ |
| | | | Zr(OH)₄ | | | | |
| Forming | Extrusion | Tabletting | Extrusion | Extrusion | Extrusion | Extrusion | Extrusion |
| process | | | | | | | |
| Shape | Cylinders | Tablet | Trilobes | Cylinders | Cylinders | Trilobes | Trilobes |
| (diameter) | (1.2 mm) | (3.3 mm) | (1.3 mm) | (1.6 mm) | (1.6 mm) | (1.3 mm) | (1.3 mm) |
| Additive | — | — | 10% | 5% nitric | 5% | zirconium | zirconium |
| | | | nitric acid | acid | ammonia | nitrate | acetate |
| Calcination | — | 300 | 400 | 400 | 400 | 400 | 400 |
| temperature | | | | | | | |
| (° C.) | | | | | | | |
| Radial crush | 17.7 | 57 | 40.2 | 20.6 | 23.5 | 46.1 | 39.2 |
| strength (N) | | | | | | | |
| Pore volume | 0.28 | 0.14 | 0.18 | 0.23 | 0.25 | 0.18 | 0.14 |
| (mL/g) | | | | | | | |
| BET surface | 97.4 | 178.8 | 29.9 | 84.6 | 95.3 | 76.9 | 74.3 |
| area | | | | | | | |
| (m²/gₛᵤₚₚₒᵣₜ) | | | | | | | |
| Acid sites | 20.23 | 13.87 | 31.34 | 25.16 | 25.98 | — | 20.86 |
| (μL_{NH3}/m²) | | | | | | | |
| Basic sites | 0.0088 | 0.0054 | 0.0155 | 0.0135 | 0.0119 | 0.013 | 0.0107 |
| (wt %/m² from | | | | | | | |
| MBOH test) | | | | | | | |

| | C1 | C2 | C3 | C4 | C5 | C6 | C7 |
|---|---|---|---|---|---|---|---|
| Impregnation | co- | sequential | co- | co- | co- | co- | co- |
| route | impreg | | impreg | impreg | impreg | impreg | impreg |
| Relative | 1.86 | 1.00 | 1.61 | 1.96 | 2.25 | 2.06 | 2.04 |
| activity (H₂ | | | | | | | |
| consumption | | | | | | | |
| @ 242° C.) | | | | | | | |

Analysis of the data in Table 1 indicated the following:
Good crush strength could be achieved when using either Zr(OH)₄ or ZrO₂ as raw material;
The addition of zirconium nitrate (S6) or zirconium acetate (S7) is beneficial for strength, particularly zirconium nitrate;

FIG. 1 shows the relationship between basic sites/BET area and activity. The activity peaks for C5 which is based on support S5 having a basic site density of 0.0119 wt %/m² from MBOH test.

FIG. 2 shows the relationship between acidic sites/BET area and activity. The relationship is less pronounced than for basic site density.

### Variation of Metal Loading

Various catalysts were prepared by the general procedures reported above. The quantities of ammonium molybdate, palladium nitrate and tin oxalate were varied in order to investigate the role of metal loading. The supports were varied in order to investigate the role of the support. A statistical model was applied to the data to look for correlations between properties and catalyst activity. The model found that catalyst were statistically significant correlations between catalyst activity and (1) Mo content, and (2) metal surface area. A selection of the data is reported in Tables 2 and 3.

TABLE 2

| | | | | | | Metal | Relative |
|---|---|---|---|---|---|---|---|
| Impregnation | | | | | | surface | activity (H₂ |
| route (co-/ | | | Pd | Mo | Sn | area | consumption |
| sequential) | Example | Support | (wt %) | (wt %) | (wt %) | (m²/g_{cat}) | @ 242° C.) |
| co- | C8 * | S1 | 2.42 | 2.22 | 0.54 | 1.89 | 1.00 |
| co- | C9 | S6 | 1.06 | 2.02 | 0.23 | 1.7 | 0.76 |
| co- | C10 | S4 | 1.08 | 2 | 0.28 | 1.98 | 0.95 |
| co- | C11 | S5 | 1.06 | 2.01 | 0.25 | 2.1 | 1.10 |

* comparative

The results in Table 2 compare a series of catalysts having approximately the same Pd, Mo and Sn contents (the target was 1 wt % Pd, 2 wt % Mo and 0.25 wt % Sn) but using different supports. Varying the support can be used to influence the metal surface area and in turn the activity. Surprisingly, it was possible to match and even outperform a catalyst having a much higher Pd content (C8) by selecting appropriate contents of Pd, Mo and Sn and by selecting an appropriate support.

TABLE 3

| | | | | | | | Relative |
|---|---|---|---|---|---|---|---|
| Impregnation | | | | | | BET | activity (H₂ |
| route (co- / | | | Pd | Mo | Sn | area | consumption |
| sequential) | Example | Support | (wt %) | (wt %) | (wt %) | (m²/g_{cat}) | @ 242° C.) |
| co- | C8 * | S1 | 2.42 | 2.22 | 0.54 | 1.89 | 1.00 |
| sequential | C12 | S1 | 0.53 | 1.48 | 0.15 | 1.32 | 0.74 |
| co- | C13 | S1 | 0.97 | 1.87 | 0.25 | 1.31 | 0.90 |
| sequential | C14 | S1 | 0.41 | 2.01 | 0.09 | 1.29 | 0.96 |
| sequential | C15 | S1 | 0.41 | 2.2 | 0.17 | 1.31 | 1.16 |

* comparative

The results in Table 3 compare a series of catalysts having the same support and approximately the same metal surface area. Because metal surface area is a parameter which is influenced by numerous factors including the loadings of metals (Pd, Mo and Sn) and the identity of the support, it is not possible to systematically vary the contents of Pd, Mo and Sn at a constant metal surface area. However, the statistical model showed that Mo content correlated positively with catalyst activity and this can be seen by comparison of C14 and C15. Surprisingly, it was possible to match and even outperform a catalyst having a much higher Pd content C8 by selecting appropriate contents of Pd, Mo and Sn.

Analysis of the data from examples C1 to C15 indicated the following relationships:
H₂ consumption was improved by increasing Mo content;
H₂ consumption was improved by increasing metal surface area.

By careful selection of the support and contents of Pd, Mo and Sn, it proved possible to reduce the Pd content from 2 wt % (C8) to 0.4 wt % (C15) without sacrificing catalyst activity.

1. A catalyst for the hydrodeoxygenation of alcohols, comprising:
0.1 to 1.5 wt % palladium;
1.0 to 5.0 wt % molybdenum; and
0.05 to 0.5 wt % tin;
on a zirconia support.

2. A catalyst as claimed in claim 1, wherein the catalyst comprises 0.1 to 1.0 wt % palladium.

3. A catalyst as claimed in claim 1 or claim 2, wherein the catalyst comprises 1.0 to 3.0 wt % molybdenum.

4. A catalyst as claimed in any of claims 1 to 3, wherein the catalyst comprises 0.05 to 0.3 wt % tin.

5. A catalyst as claimed in any of claims 1 to 4, wherein the catalyst has a metal surface area of ≥1.0 m²/g_{cat} when measured by CO chemisorption.

6. A catalyst as claimed in any of claims 1 to 5, wherein the catalyst has a metal surface area of 1.0 to 3.0 m²/g_{cat} When measured by CO chemisorption.

7. A catalyst as claimed in any of claims 1 to 6, wherein the catalyst is in the form of a shaped body.

8. A catalyst as claimed in claim 7, wherein the shaped body has a spherical cross-section.

9. A catalyst as claimed in claim 7, wherein the shaped body has a trilobe cross-section.

10. A catalyst as claimed in claim 9, wherein the shaped body has a trilobe cross-section with an average diameter of 1.0 to 4.0 mm.

11. A catalyst as claimed in any of claims 1 to 10, wherein the content of metals other than palladium, molybdenum, tin and zirconium present in the catalyst is ≤0.1 wt % based on the total weight of the catalyst, if any such metals are present at all.

12. A catalyst as claimed in any of claims 1 to 11, wherein the support has a total pore volume of 0.10 to 0.40 mL/g when measured by N₂ physisorption.

13. A catalyst as claimed in any of claims 1 to 12, wherein the support has an acid site density of 15 to 30 μL_{NH3}/m².

14. A catalyst as claimed in any of claims 1 to 13, wherein the support has an acid site density of 19 to 28 μL_{NH3}/m².

15. A catalyst as claimed in any of claims 1 to 14, wherein the support has a basic site density of 0.006 to 0.015 wt %/m² as measured by the MBOH test.

16. A catalyst as claimed in any of claims 1 to 15, wherein the support has a basic site density of 0.075 to 0.014 wt %/m² as measured by the MBOH test.

17. A method of manufacturing a hydrodeoxygenation catalyst, comprising the steps of:
(i) dissolving a palladium salt, a molybdenum salt, a tin salt and a chelating agent together to produce an impregnation solution;
(ii) adding the impregnation solution to a zirconia support to provide an impregnated support;
(iii) drying the impregnated support; and
(iv) calcining the impregnated support to produce the hydrodeoxygenation catalyst;
wherein the hydrodeoxygenation catalyst is as defined in any of claims 1 to 16.

18. A method as claimed in claim 17, wherein the chelating agent is citric acid.

19. A method as claimed in claim 17 or claim 18, wherein the support has a total pore volume of 0.10 to 0.40 mL/g when measured by N₂ physisorption.

20. A method as claimed in any of claims 17 to 19, wherein the support has an acid site density of 15 to 30 μL_{NH3}/m².

21. A method as claimed in any of claims 17 to 19, wherein the support has an acid site density of 19 to 28 μL_{NH3}/m².

22. A method as claimed in any of claims 17 to 21, wherein the support has a basic site density of 0.006 to 0.015 wt %/m² as measured by the MBOH test.

23. A method as claimed in any of claims 17 to 21, wherein the support has a basic site density of 0.075 to 0.014 wt %/m² as measured by the MBOH test.

24. A method as claimed in any of claims 17 to 23, wherein the palladium salt is palladium nitrate.

25. A method as claimed in any of claims 17 to 24, wherein the molybdenum salt is ammonium molybdate.

26. A method as claimed in any of claims 17 to 25, wherein the tin salt is tin oxalate.

27. A method as claimed in any of claims 17 to 26, wherein the calcination in step (iv) is carried out at 350-450° C.

28. A hydrodeoxygenation process comprising the step of treating a feed stream comprising a carbohydrate feedstock with a catalyst to produce a lower molecular weight oxygenated compound, wherein the catalyst is defined in any of claims 1 to 16.

29. A hydrodeoxygenation process according to claim 28, wherein the feed stream comprises a sugar and/or a sugar alcohol.
